(19) United States
(12) Patent Application Publication
(10) Pub. No.: US 2020/0339262 A1
(43) Pub. Date: Oct. 29, 2020

(54) Galley Cart Wheel Track

(71) Applicant: B/E Aerospace, Inc., Winston-Salem, NC (US)

(72) Inventors: Shawn A. Claflin, Seattle, WA (US); Brandon L. Popple, Everett, WA (US)

(21) Appl. No.: 16/397,014

(22) Filed: Apr. 29, 2019

(51) Int. Cl. B64D 11/00; B62B 3/00; B62B 5/00; B60B 33/00; B64D 11/04

(52) U.S. Cl. CPC B64D 11/0007; B62B 3/005; B62B 5/0083; B62B 2301/254; B64D 11/04; B62B 2202/67; B62B 2301/04; B60B 33/0042

(57) ABSTRACT

A galley cart compartment is disclosed. In embodiments, the galley cart compartment includes an interior compartment or space having left and right sidewalls and a cabin floor. The interior compartment can receive and securely store a galley cart (e.g., trolley) insertable into, and removable from, the interior compartment along an axis of entry (e.g., parallel to the depth of the interior compartment). The galley cart has left and right sides and an underside to which casters are pivotably or rotatably attached, each caster has left and right wheels separated by a wheel gap. Tracks extend along the cabin floor parallel to the axis of entry, a left and right track positioned to engage respectively with the left-side and right-side casters. Each track includes a guide rail that projects into the wheel gap, preventing the caster wheels from rotating when the galley cart is removed from the interior compartment.

### BACKGROUND

Aircraft galley structures may incorporate cart compartments and cart bays configured for temporary storage of galley carts (e.g., service carts, trolleys). Cart bays may be configured to store galley carts while minimizing the space they occupy, e.g., the inner dimensions of a cart bay may be as compact as possible. Galley carts may include wheels on casters mounted to their undersides, via which the galley carts may be inserted into their respective cart bays for secure storage (e.g., during taxi, takeoff and landing segments). The galley carts may similarly be removed from their bays for in-seat catering or food service, via which the carts may be transported along aircraft aisles and ultimately returned to their bays. The entry and exit of a galley cart into its cart bay may be guided by rubstrips or similar barriers on the walls of the cart bay.

The casters of the galley carts are designed to allow full 360-degree rotation by the cart wheels. When a galley cart is inserted into a cart bay, its caster wheels will all be oriented in the same direction, e.g., toward the back of the cart bay. When the galley cart is next removed from the cart bay, the initial reaction of the underside casters is to rotate the wheels 180 degrees to face the opposite direction. As the cart bay is too narrow to accommodate a full rotation, the result may be a caster or wheel rotation into the cart bay wall (or into a nearby rubstrip) at an angle associated with a binding or jamming of the wheel into the rubstrip. This binding or jamming action may significantly increase the force required to remove a galley cart from its cart bay. As multiple galley carts may be removed from, and reinserted into, their cart bays multiple times during the course of a normal flight, the cumulative additional force may vastly increase the workload for flight attendants and cabin crew. Further, random damage due to wheel binding or jamming may increase wear and tear on the sidewalls and rubstrips of the galley cart bays as well as the galley carts themselves.

### SUMMARY

A galley cart compartment is disclosed. In embodiments, the galley cart compartment includes an interior compartment (e.g., interior space) of an aircraft galley complex (galley structure, galley monument). The interior compartment includes left and right sidewalls and a floor, which may be the cabin floor. The interior compartment is capable of receiving a galley cart (e.g., trolley) insertable into, and removable from, the interior compartment along an axis of entry (e.g., parallel to the depth of the interior compartment). The galley cart has an outer housing with left and right sides and an underside, to which casters are pivotably or rotatably attached on the left and right sides. Each caster has a left and right (inside and outside) wheel, the two wheels separated by an interior wheel gap or space. Tracks extend along the cabin floor parallel to the axis of entry (e.g., from the front to the rear of the interior compartment), a left track and a right track positioned to engage respectively with the left-side and right-side casters. Each track includes a guide rail capable of partially extending into the wheel gap, preventing the caster wheels from laterally rotating when the galley cart is first removed from the interior compartment.

A galley cart wheel track system is also disclosed. In embodiments, the galley cart wheel track system includes a galley cart compartment (e.g., of a galley complex or galley monument) having two or more adjacent cart bays. Each cart bay is adjacent to a compartment wall (e.g., a compartment may include a left bay adjacent to the left inside wall and a right bay adjacent to the right inside wall). Each cart bay can accommodate a galley cart insertable into, and removable from, the cart bay along an axis of entry (e.g., parallel to the depth of the cart bay). Each galley cart has an outer housing including an outside face adjacent to the compartment wall, an inside wall opposite the outside wall, and an underside. Casters are attached to the underside of each galley cart on the inside and outside (e.g., the sides respectively closest to and farthest from the compartment wall), each caster having a left wheel and a right wheel separated by a wheel gap. Each cart bay includes a floor, which may be the galley floor, along with a track extends, parallel to the axis of entry and close to the compartment wall. The track includes a guide rail capable of extending into the wheel gaps of the set of casters closest to the compartment wall and preventing the casters from laterally rotating when the galley carts are removed from the cart bays.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is an isometric view illustrating a galley cart compartment in accordance with example embodiments of this disclosure;

FIG. 2 is a detailed view of a galley cart and track of the galley cart compartment of FIG. 1,

FIG. 3 is an isometric view illustrating a galley cart compartment in accordance with example embodiments of this disclosure;

FIG. 4 is an isometric view illustrating a galley cart compartment in accordance with example embodiments of this disclosure;

FIGS. 5A and 5B are respectively isometric and forward views illustrating a guide rail of the galley cart compartment of FIGS. 1, 3, and 4; and

FIG. 6 is a forward view illustrating a galley cart track system of the galley cart compartment of FIGS. 1 through 5B.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

A cart wheel track system for cart compartments (e.g., cart bays) is disclosed. The cart bays may be incorporated into aircraft galley configurations, e.g., galley structures, galley monuments, or structures otherwise mounted in an aircraft passenger cabin and incorporating cart bays. Guide rails on the floor of the cart bays prevent the cart wheels from rotating on removal from the bay, facilitating easy removal of the cart. Further, the guide rails may assist in the smooth return of the cart to its bay, preventing unnecessary impact with the compartment sidewalls or rubstrips attached thereto.

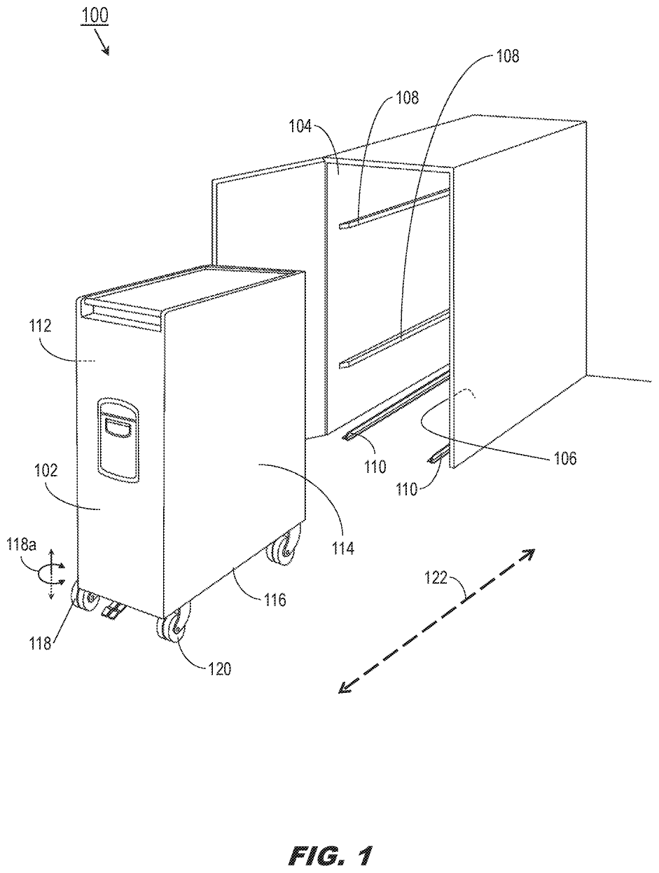

Referring to FIG. 1, a galley cart compartment 100 is disclosed. The galley cart compartment 100 may be configured to accept and securely store a galley cart 102, and may include a left sidewall 104, a right sidewall 106, rubstrips 108, and tracks 110. The galley cart 102 may include an exterior housing having a left side 112, a right side 114, and an underside 116 with left-side casters 118 and right-side casters 120 attached thereto. The galley cart 102 may be inserted into, and removed from, the galley cart compartment 100 along a fixed axis of entry 122, e.g., parallel to the left and right sidewalls 104, 106 and rubstrips 108. Each left-side caster 118 and right-side caster 120 may be rotatably attached to the underside 116 of the galley cart 102, such that the left-side and right-side casters may be capable of a full 360 degrees of rotation (118a) relative to the galley cart 102.

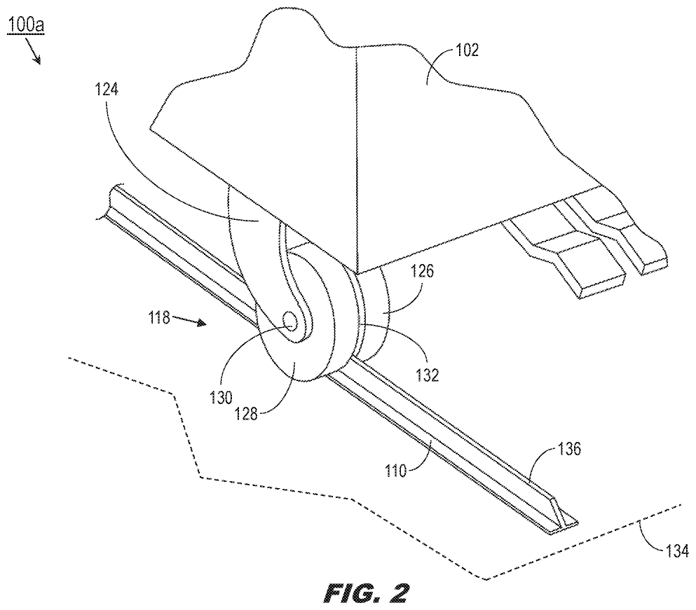

Referring to FIG. 2, a galley cart compartment 100a is disclosed. The galley cart compartment 100a may be implemented and may function similarly to the galley cart compartment 100 of FIG. 1, except that each left-side caster 118 (and each right-side caster 120, FIG. 1) may include a fork 124 enclosing two wheels, an inside wheel 126 and an outside wheel 128 (the outside wheel being proximate to the left sidewall 104), sharing a common axle 130 and separated by a wheel gap 132.

In embodiments, each track 110 may be set into the floor 134 of the galley cart compartment 100a (which floor may be the galley floor or the floor of the passenger cabin). The tracks 110 may be set into the floor 134 by bolting, fastening, adhering, or any other appropriate means for securing the guide rails to the floor in the desired alignment.

In embodiments, the tracks 110 may include guide rails 136 extending upward into the wheel gap 132 between the inside and outside wheels 126, 128 such that, when a crewmember initiates the removal of the galley cart 102a from the galley cart compartment 100a into which the galley cart is fully inserted (e.g., by pulling outward, substantially parallel to the axis of entry (122, FIG. 1) on a handle attached to the forward face of the exterior housing of the galley cart), the left-side casters 118 are restrained from rotating 180 degrees. Instead, the inside wheels 126 and outside wheels 128 of each left-side caster 118 follow the guide rails 136, remaining substantially parallel to the axis of entry 122 as the galley cart 102 is removed from the galley cart compartment 100a. Similarly, tracks 110 and guide rails 136 extend between the inside and outside wheels 126, 128 of the right-side casters (120, FIG. 1), preventing the right-side casters 120 from rotating more than a trace amount when the galley cart 102 is removed from the galley compartment 100a. The guide rails 136 may be of any appropriate shape to extend partially into the wheel gaps 132 and prevent lateral rotation of the left-side and right-side casters 118, 120.

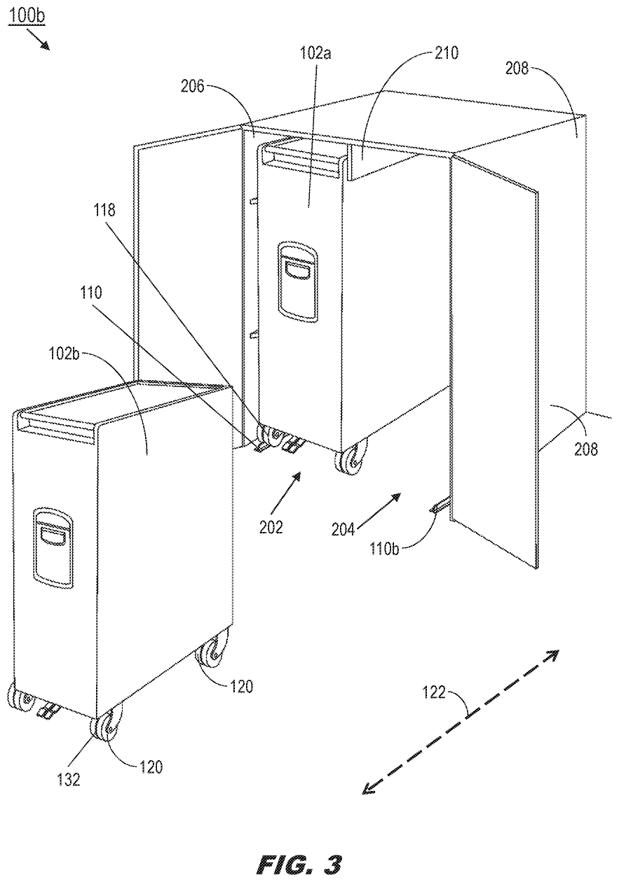

Referring to FIG. 3, a galley cart compartment 100b is disclosed. The galley cart compartment 100b may be implemented and may function similarly to the galley cart compartment 100a of FIG. 2, except that the galley cart compartment 100b may include two adjacent left and right cart bays 202, 204 respectively configured to receive and store galley carts 102a-b.

In embodiments, the left cart bay 202 may be adjacent to a left compartment wall 206 of the galley cart compartment 100b while the right cart bay 204 is adjacent to a right compartment wall 208 of the galley cart compartment. The left and right cart bays 202, 204 may be separated by a central partition 210 which may assist in guiding the respective galley carts 102a-b into, and out of, their respective left and right cart bays (e.g., parallel to the axis of entry 122).

In embodiments, the left cart bay 202 may incorporate a left-side track 110a proximate to the left compartment wall 206 and positioned to engage with the wheel gaps 136 of the left-side casters 118 of the galley cart 102a. Similarly, the right cart bay 204 may incorporate a right-side track 110b proximate to the right compartment wall 208 and positioned to engage with the wheel gaps 132 of the right-side casters 120 of the galley cart 102b.

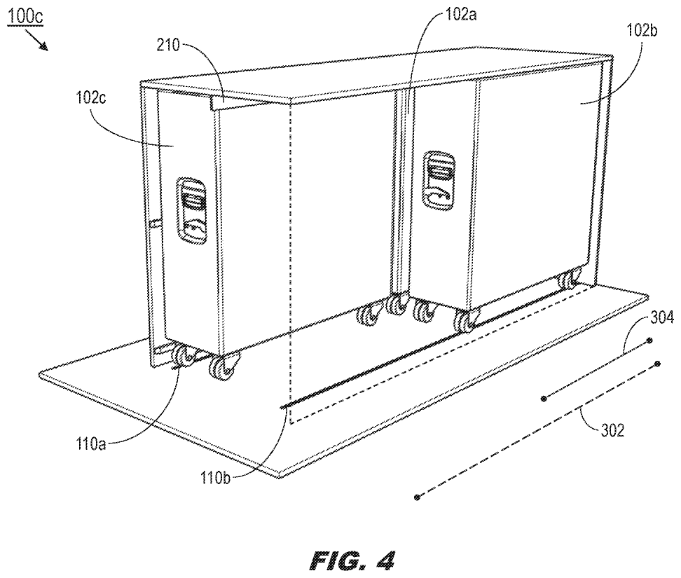

Referring to FIG. 4, a galley cart compartment 100c is disclosed. The galley cart compartment 100c may be implemented and may function similarly to the galley cart compartment 100b of FIG. 3, except that the galley cart compartment 100c may have a compartment depth 302 approximately twice that of the cart depth 304 of the galley carts 102a-c.

In some embodiments, the left and right tracks 110a-b may extend along the cabin floor 134 of the galley cart compartment 100c for a sufficient length that the galley cart compartment 100c may accommodate, in front of the galley carts 102a-b, a second row of galley carts (102c). For example, the galley carts 102a-b may be inserted into the galley cart compartment 100c and guided along straight paths by the left and right tracks 110a-b and the central partition 210 to the rear of the galley cart compartment 100c. Flight attendants and cabin crew may then be able to insert the second galley cart 102c into the galley cart compartment 100c (e.g., guided by the left track 110a and central partition 210). In some embodiments, the galley cart compartment 100c may be equipped with any appropriate means of removing the galley carts 102a-b from the rear of the galley cart compartment once the galley cart 102c is removed.

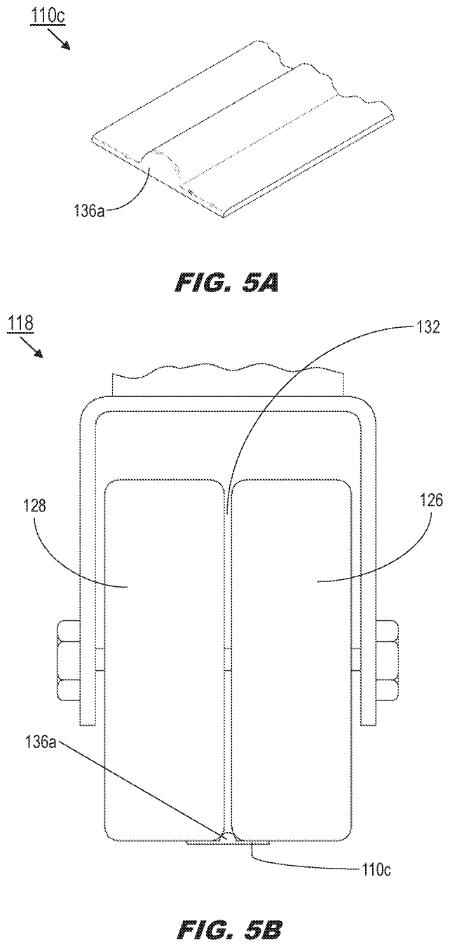

Referring to FIGS. 5A and 5B, a track 110c is disclosed. The track 110c may be implemented and may function similarly to the tracks 110, 110a-b of FIGS. 1-4, except that the track 110c may incorporate a substantially rounded guide rail 136a. For example, the rounded guide rail 136a may be rounded or substantially spherical at the front end of the track 110c, where the guide rail first encounters the wheel gap 132 between the inside and outside wheels 126, 128 of the caster 118, and taper into another shape along its length. Alternatively, the rounded guide rail 136a may present a uniformly round cross-section at any point along its length. For example, the rounded guide rail 136a may assist the inside and outside wheels 126, 128 in self-aligning to the track 110c when first introduced to the galley cart compartment (100, 100a-c; FIGS. 1-4), while projecting far enough into the wheel gap 132 to keep the inside and outside wheels aligned once the caster 118 is fully engaged with the track 110c.

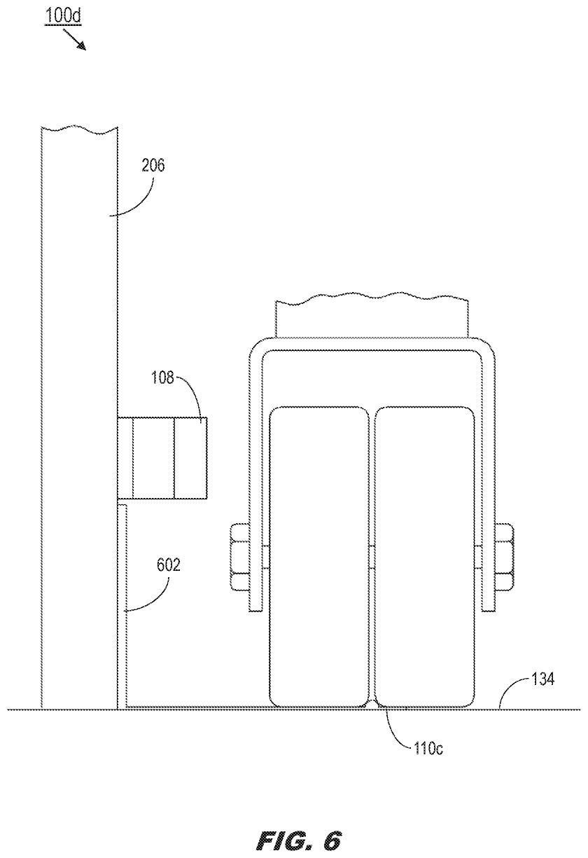

Referring to FIG. 6, a galley cart compartment 100d is disclosed. The galley cart compartment 100d may be implemented and may function similarly to the galley cart compartments 100, 100c of FIGS. 1-5B, except that the left track 110c may be mounted to the left compartment wall 206 (or the left sidewall 104, FIG. 1) as opposed to the cabin floor 134. For example, the left track 110c may be incorporated into a mount (602) attached to the left compartment wall 206.

In some embodiments, the mount 602 may be attached or mounted to the lower left rubstrip 108, and the rubstrip in turn mounted to the left compartment wall 206. In some embodiments, the left track 110a and the left rubstrip 108 may be incorporated into a single mount 602 attachable or mountable to the left compartment wall 206. In embodiments, the right track (110b, FIG. 3) may be similarly incorporated into the right compartment wall 208 (or the right sidewall 106 (FIG. 1), or the right rubstrip (108, FIG.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

We claim:

1. A galley cart compartment, comprising:
an interior compartment associated with an aircraft galley complex, the interior compartment bounded by at least a left sidewall, a right sidewall, and a cabin floor, the interior compartment configured to accommodate a galley cart insertable into and removable from the interior compartment along an axis of entry, the galley cart comprising:
an exterior housing including at least a left side, a right side, and an underside;
and
a left-side plurality of casters and a right-side plurality of casters pivotably attached to the underside, each caster including a left wheel and a right wheel separated by a wheel gap;
and
a set of tracks proximate to the cabin floor and parallel to the axis of entry, the set of tracks comprising:
a left track proximate to the left sidewall, the left track including a left guide rail configured for extending into at least one wheel gap of the left-side plurality of casters;
and
a right track proximate to the right sidewall, the right track including a right guide rail configured for extending into at least one wheel gap of the right-side plurality of casters.

2. The galley cart compartment of claim 1, wherein at least one of the left track and the right track are mounted to the cabin floor.

3. The galley cart compartment of claim 1, wherein:
the left track is mounted to the left sidewall;
and
the right track is mounted to the right sidewall.

4. The galley cart compartment of claim 1, further comprising:
at least one left rubstrip mounted to the left sidewall and extending parallel to the axis of entry;
and
at least one left rubstrip mounted to the right sidewall and extending parallel to the axis of entry.

5. The galley cart compartment of claim 4, wherein:
the left track is mounted to the left rubstrip;
and
the right track is mounted to the right rubstrip.

6. The galley cart compartment of claim 4, wherein:
the left track and the left rubstrip are collectively mounted to the left sidewall;
and
the right track and the right rubstrip are collectively mounted to the right sidewall.

7. The galley cart compartment of claim 1, wherein at least one of the left guide rail and the right guide rail has at least one of a rounded edge and a rounded cross section.

8. The galley cart compartment of claim 1, wherein the galley cart is a first galley cart and:
the galley cart has a cart depth parallel to the axis of entry;
the interior compartment has a compartment depth parallel to the axis of entry, the compartment depth at least twice the cart depth;
and
the interior compartment is configured to accommodate at least the first galley cart and a second galley cart, the second galley cart also having the cart depth.

9. A galley cart wheel track system, comprising:
a galley cart compartment associated with an aircraft galley, the galley cart compartment comprising a plurality of adjacent cart bays, each cart bay having at least one compartment wall and configured to accommodate a galley cart insertable into and removable from the cart bay along an axis of entry, each galley cart comprising:
an exterior housing including at least an outside wall adjacent to the compartment wall, an inside wall opposite the outside wall, and an underside;
and
an inside plurality of casters and an outside plurality of casters attached to the underside, the outside plurality of casters proximate to the outside wall, each caster including a left wheel and a right wheel separated by a wheel gap;
and
each cart bay having a bottom defined by a cabin floor and including a track proximate to the cabin floor, the track proximate to the compartment wall and parallel to the axis of entry, the track including a guide rail configured for extending into at least one wheel gap of the outside plurality of casters when the galley cart is in the axis of entry.

10. The galley cart wheel track system of claim 9, wherein:
the plurality of cart bays includes a left cart bay adjacent to a left compartment wall and a right cart bay adjacent to a right compartment wall, the left cart bay and the right cart bay partially separated by a partition;
the left cart bay including a left track proximate to the left compartment wall;
and
the right cart bay including a right track proximate to the right compartment wall.

11. The galley cart wheel track system of claim 10, wherein the left track and the right track are mounted to the cabin floor.

12. The galley cart wheel track system of claim 10, wherein:
the left track is mounted to the left compartment wall;
and
the right track are mounted to the right compartment wall.

13. The galley cart wheel track system of claim 10, further comprising:
at least one left rubstrip mounted to the left compartment wall and extending parallel to the axis of entry;
and
at least one right rubstrip mounted to the right compartment wall and extending parallel to the axis of entry.

14. The galley cart wheel track system of claim 13, wherein:
the left track is mounted to the left rubstrip;
and
the right track is mounted to the right rubstrip.

15. The galley cart wheel track system of claim 13, wherein:
the left track and the left rubstrip are collectively mounted to the left compartment wall;
and
the right track and the right rubstrip are collectively mounted to the right compartment wall.

16. The galley cart wheel track system of claim 10, wherein at least one of the left track and the right track have at least one of a rounded edge and a rounded cross section.

17. The galley wheel track system of claim 9, wherein the galley cart is a first galley cart and:
the galley cart has a cart depth parallel to the axis of entry;
each cart bay has a bay depth parallel to the axis of entry, the bay depth at least twice the cart depth;
and
each cart bay is configured to accommodate at least the first galley cart and a second galley cart, the second galley cart also having the cart depth.
